(19) United States
(12) Patent Application Publication
(10) Pub. No.: US 2023/0296972 A1
(43) Pub. Date: Sep. 21, 2023

(54) LIGHT SOURCE DEVICE AND IMAGE DISPLAY APPARATUS

(71) Applicant: SONY GROUP CORPORATION, TOKYO (JP)

(72) Inventors: MARIKO OBINATA, TOKYO (JP); TAKEHARU TAKASAWA, TOKYO (JP)

(21) Appl. No.: 18/041,448

(22) PCT Filed: Aug. 10, 2021
(86) PCT No.: PCT/JP2021/029517

§ 371 Date: Feb. 13, 2023

(30) Foreign Application Priority Data
Aug. 25, 2020 (JP) 2020-141972

(51) Int. Cl. G03B 21/20

(52) U.S. Cl. CPC G03B 21/2013; G03B 21/2073; G03B 21/2033; G03B 21/2066

(57) ABSTRACT

A light source device according to an embodiment of the present technology includes: a first light source unit; a polarization split element; a second light source unit; a light synthesis unit; a polarization synthesis element. The first light source unit emits light having a predetermined wavelength band and in an unpolarized state. The polarization split element splits emitted light emitted from the first light source unit into first split light in a first polarization state and second split light in a second polarization state. The second light source unit emits one or more laser beams each having a wavelength band included in the predetermined wavelength band. The light synthesis unit synthesizes the first split light and the one or more laser beams and emits the obtained light as synthesized light in the first polarization state. The polarization synthesis element synthesizes the synthesized light and the second split light.

### TECHNICAL FIELD

The present technology relates to a light source device and an image display apparatus.

### BACKGROUND ART

The light source device described in Patent Literature 1 includes a first light source unit 24 and a second light source unit 25. The first light source unit 24 is used as a light source for irradiating (exciting) a phosphor material. The second light source unit 25 emits light in a wavelength range of a color that is insufficient for synthesized light of the light from the first light source and the emitted light emitted from the phosphor material. As a result, a light source device with high efficiency and excellent color reproducibility is realized (paragraphs [0015] and [0029] of the specification of Patent Literature 1, etc.).

### CITATION LIST

### Patent Literature

Patent Literature 1: Japanese Patent Application Laid-open No. 2014-186115

### DISCLOSURE OF INVENTION

### Technical Problem

As described above, a light source device with high efficiency and excellent color reproducibility is desired.

In view of the circumstances as described above, it is an object of the present technology to provide a light source device and an image display apparatus with high efficiency and excellent color reproducibility.

### Solution to Problem

In order to achieve the above-mentioned object, a light source device according to an embodiment of the present technology includes: a first light source unit; a polarization split element; a second light source unit; a light synthesis unit; and a polarization synthesis element.

The first light source unit emits light having a predetermined wavelength band and in an unpolarized state.

The polarization split element splits emitted light emitted from the first light source unit into first split light in a first polarization state and second split light in a second polarization state.

The second light source unit emits one or more laser beams each having a wavelength band included in the predetermined wavelength band.

The light synthesis unit synthesizes the first split light and the one or more laser beams and emits the obtained light as synthesized light in the first polarization state.

The polarization synthesis element synthesizes the synthesized light and the second split light.

In this light source device, light having a predetermined wavelength band and in an unpolarized state is split into first split light and second split light. The first split light is synthesized with one or more laser beams and the obtained synthesized light is synthesized with second split light. As a result, it is possible to realize a light source device with high efficiency and excellent color reproducibility.

The first light source unit may emit lamp light, LED (Light Emitting Diode) light, or emitted light emitted from a light-emitting material.

The first light source unit may emit light having at least a yellow wavelength band. In this case, the second light source unit may emit at least one of a red laser beam or a green laser beam.

The light synthesis unit may include a filter element disposed in an optical path of the one or more laser beams and an optical element that emits the first split light toward the filter element.

The filter element may include a wavelength filter that causes light in a wavelength band of each of the one or more laser beams to be transmitted therethrough and reflects light in a wavelength band different from the wavelength band of each of the one or more laser beams, and may emit the synthesized light by causing the one or more laser beams to be transmitted therethrough and reflecting the first split light.

The filter element may include a wavelength filter that reflects light in a wavelength band of each of the one or more laser beams and causes light in a wavelength band different from the wavelength band of each of the one or more laser beams to be transmitted therethrough, and may emit the synthesized light by reflecting the one or more laser beams and causing the first split light to be transmitted therethrough.

The filter element may include a spatial filter that includes an opening at a position of the optical path of the one or more laser beams and a mirror at a position different from that of the optical path of the one or more laser beams, and may emit the synthesized light by causing the one or more laser beams to be transmitted through the opening and reflecting the first split light by the mirror.

The filter element may include a spatial filter that includes a mirror at a position of the optical path of the one or more laser beams and an opening at a position different from that of the optical path of the one or more laser beams, and may emit the synthesized light by reflecting the one or more laser beams by the mirror and causing the first split light to be transmitted through the opening.

The polarization split element may split the emitted light emitted from the first light source unit into s-polarized light that is the first split light and p-polarized light that is the second split light. In this case, the second light source unit may emit the one or more laser beams as light in the same polarization state as the s-polarized light. Further, the light synthesis unit may emit the synthesized light as light in the same polarization state as the s-polarized light. Further, the polarization synthesis element may synthesize the synthesized light and the p-polarized light.

The polarization split element may split the emitted light emitted from the first light source unit into p-polarized light that is the first split light and s-polarized light that is the second split light. In this case, the second light source unit may emit the one or more laser beams as light in the same polarization state as the p-polarized light. Further, the light synthesis unit may emit the synthesized light as light in the same polarization state as the p-polarized light. The polarization synthesis element may synthesize the synthesized light and the s-polarized light.

Each of the polarization split element and the polarization synthesis element may include a polarizing beam splitter.

The first light source unit may include an excitation light source and a light-emitting material that is excited by excitation light emitted from the excitation light source to emit light. In this case, the excitation light source may emit the excitation light as light in the first polarization state. Further, the optical element may cause light in a wavelength band of the excitation light to be transmitted therethrough and reflect light in a wavelength band different from the wavelength band of the excitation light. Further, the excitation light may be transmitted through the optical element and then applied to the light-emitting body via the polarization split element.

The first light source unit may include an excitation light source and a light-emitting material that is excited by excitation light emitted from the excitation light source to emit light. In this case, the excitation light source may emit the excitation light as light in the first polarization state. Further, the optical element may reflect light in a wavelength band of the excitation light and cause light in a wavelength band different from the wavelength band of the excitation light to be transmitted therethrough. Further, the excitation light may be reflected by the optical element and then applied to the light-emitting body via the polarization split element.

The light source device may further include a mirror that reflects leakage light that has not been emitted as the synthesized light by the filter element, of the first split light, so as to travel in an opposite direction of an optical path of the first split light from the optical element to the filter element.

An image display apparatus according to an embodiment of the present technology includes: the light source unit; an image generation system; and a projection system.

The image generation system generates an image on the basis of light from the light source device.

The projection system projects the image generated by the image generation system.

### BRIEF DESCRIPTION OF DRAWINGS

FIG. 1 is a schematic diagram showing a configuration example of an image display apparatus according to an embodiment of the present technology.

FIG. 2 is a schematic diagram for describing an outline of a light source device.

FIG. 3 is a schematic diagram showing a specific configuration example of the light source device.

FIG. 4 is a graph for describing characteristics of an optical element and a light source included in the light source device.

FIG. 5 is a schematic diagram showing a configuration example of a light source device according to a Comparative Example.

FIG. 6 is a graph for describing characteristics of an optical element and a light source included in the light source device according to the Comparative Example.

FIG. 7 is a schematic diagram showing another configuration example of the light source device.

FIG. 8 is a schematic diagram showing another example of a first light source unit.

FIG. 9 is a schematic diagram for describing each device and characteristics of light in the case where the configuration shown in FIG. 8 is adopted.

FIG. 10 is a schematic diagram showing a configuration example of the light source device in the case where a reflective phosphor light source is used.

FIG. 11 is a schematic diagram showing another configuration example of the light source device.

FIG. 12 is a schematic diagram showing an application example of the light source device.

### MODE(S) FOR CARRYING OUT THE INVENTION

Hereinafter, an embodiment according to the present technology will be described with reference to the drawings.

[Image Display Apparatus]

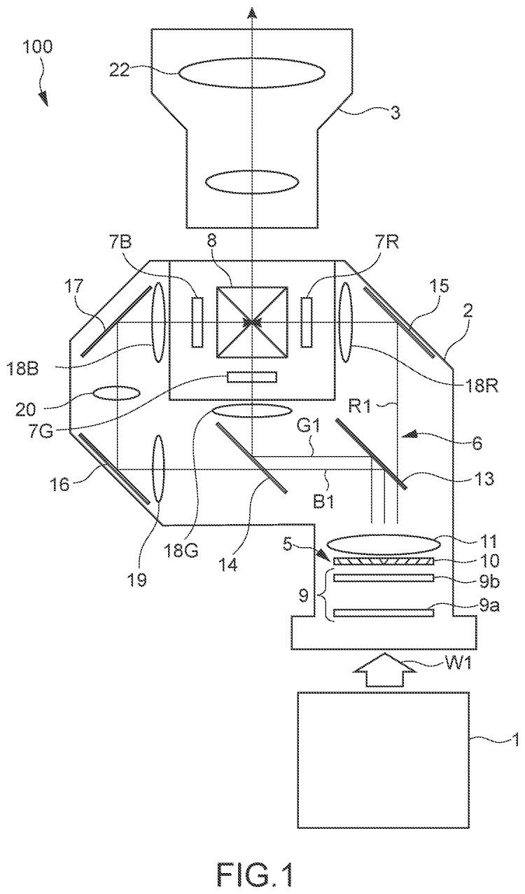

FIG. 1 is a schematic diagram showing a configuration example of an image display apparatus according to an embodiment of the present technology.

An image display apparatus 100 is used as, for example, a projector for presentation, digital cinema, or flight simulation. The present technology to be described below is applicable also to an image display apparatus used for other applications.

The image display apparatus 100 includes a light source device 1, an image generation system 2, and a projection system 3.

The light source device 1 emits white light W1 to the image generation system 2. The light source device 1 will be described below in detail.

The image generation system 2 generates an image on the basis of the white light W1 emitted from the light source device 1.

The image generation system 2 includes an integrator optical system 5, a lighting optical system 6, liquid crystal light valves 7R, 7G, and 7B as image generation elements, and a dichroic prism 8.

The integrator optical system 5 includes an integrator element 9, a polarization conversion element 10, and a condenser lens 11.

The integrator element 9 includes a first fly-eye lens 9a and a second fly-eye lens 9b, the first fly-eye lens 9a including a plurality of microlenses two-dimensionally arrayed, the second fly-eye lens 9b including a plurality of microlenses arrayed corresponding to the plurality of microlenses one by one.

The white light W1 that has entered the integrator element 9 is split into a plurality of light beams by the microlenses of the first fly-eye lens 9a and images are each formed on the corresponding microlens provided in the second fly-eye lens 9b. Each of the microlenses of the second fly-eye lens 9b functions as a secondary light source and emits a plurality of light beams with uniform luminance to the polarization conversion element 10 in the subsequent stage.

The polarization conversion element 10 has a function of making the polarization state of incident light that is incident via the integrator element 9 uniform. The light that has passed through the polarization conversion element 10 is emitted to the lighting optical system 6 via the condenser lens 11.

The lighting optical system 6 includes dichroic mirrors 13 and 14, mirrors 15, 16, and 17, field lenses 18R, 18G, and 18B, and relay lenses 19 and 20.

The dichroic mirror 13 causes red light R1 included in the white light W1 to be transmitted therethrough and reflects yellow light (green light G1 and blue light B1).

The dichroic mirror 14 reflects the green light G1 reflected by the dichroic mirror 13 and causes the blue light B1 to be transmitted therethrough.

As a result, the color light beams of R, G, and B are split into different optical paths. Note that there is no limitation on the configurations for splitting the color light beams of R, G, and B, devices to be used, and the like.

The red light R1 that has been transmitted through the dichroic mirror 13 is reflected by the mirror 15, collimated by the field lens 18R, and then enters the liquid crystal light valve 7R for modulating red light.

The green light G1 that has been reflected by the dichroic mirror 14 is collimated by the field lens 18G, and then enters the liquid crystal light valve 7G for modulating green light.

The blue light B1 that has been transmitted through the dichroic mirror 14 passes through the relay lens 19, is reflected by the mirror 16, passes through the relay lens 20, and is reflected by the mirror 17. The blue light B1 that has been reflected by the mirror 17 is collimated by the field lens 18B and then enters the liquid crystal light valve 7B for modulating blue light.

The liquid crystal light valves 7R, 7G, and 7B are electrically connected to a signal source (e.g., PC) (not shown) that supplies an image signal containing image information.

The liquid crystal light valves 7R, 7G, and 7B modulate the incident light for each pixel on the basis of the supplied image signal of the respective colors and respectively generate a red image, a green image, and a blue image. The modulated light of the respective colors (formed image) enters the dichroic prism 8 and is synthesized.

The dichroic prism 8 superimposes and synthesizes the light beams of the respective colors, which have entered from the three directions, and emits the obtained light toward the projection system 3. Note that synthesis of light can be said to be multiplexing of light.

The projection system 3 projects the image generated by the image generation system 2. The projection system 3 includes a plurality of lenses 22 and the like, and projects the light synthesized by the dichroic prism 8 onto a screen or the like (not shown).

As a result, a full-color image is displayed. The specific configuration of the projection system 3 is not limited.

[Light Source Device]

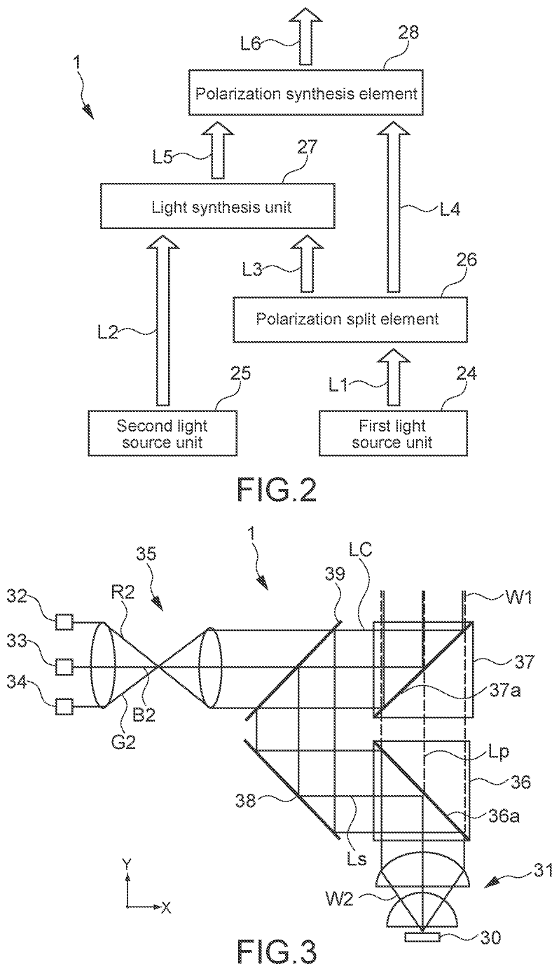

FIG. 2 is a schematic diagram for describing the outline of the light source device 1.

The light source device 1 includes a first light source unit 24, a second light source unit 25, a polarization split element 26, a light synthesis unit 27, and a polarization synthesis element 28.

The first light source unit 24 emits light L1 having a predetermined wavelength band and in an unpolarized state.

The specific value of the predetermined wavelength band is not limited. Typically, a wavelength band included in the wavelength band of visible light is selected.

For example, white light having a white wavelength band including a red wavelength band, a green wavelength band, and a blue wavelength band is emitted.

The present technology is not limited thereto, and yellow light having a yellow wavelength band including a red wavelength band and a green wavelength band may be emitted. Light in another wavelength band may be emitted.

Typically, light in a so-called broad wavelength band, i.e., light having a wide wavelength band is emitted.

Light in an unpolarized state is light that is not polarized, and includes, for example, natural light or the like. Further, light having polarization directions distributed substantially uniformly in all directions is also included in the light in the unpolarized state. Further, light including light beams having various polarization states is also included in the light in the unpolarized state. Further, light including a plurality of light beams having polarization components of substantially equal intensity and different polarization directions from each other is also included in the light in the unpolarized state.

For example, LED (Light Emitting Diode) light, lamp light, emitted light emitted from a light-emitting material, and the like are also included in the light in the unpolarized state.

Examples of the light-emitting material include a fluorescent material that is excited by excitation light to emit fluorescence. In this case, the fluorescence emitted from the fluorescent material corresponds to emitted light.

Further, quantum dots (QD) may be used as the light-emitting material. Emitted light from quantum dots is also included in the light in the unpolarized state.

The second light source unit 25 emits one or more laser beams L2 having a wavelength band included in the wavelength band of the emitted light L1 of the first light source unit 24.

In the present disclosure, in the case where the center wavelength of a laser beam is included in the wavelength band of the emitted light L1, the wavelength band of the laser beam is included in the wavelength band of the emitted light L1.

Therefore, it can be also said that the second light source unit 25 emits the one or more laser beams L2 having a center wavelength included in the wavelength band of the emitted light L1 of the first light source unit 24.

Although one laser beam L2 is illustrated in FIG. 2, the number of laser beams emitted from the second light source unit 25 is not limited.

For example, in the case where the emitted light L1 is white light, at least one of a red laser beam, a green laser beam, or a blue laser beam is emitted as the one or more laser beams L2 from the second light source unit 25.

In the case where the emitted light L1 is yellow light, at least one of a red laser beam or a green laser beam is emitted as the one or more laser beams L2 from the second light source unit 25. Such a configuration can be adopted.

Note that laser beams of the respective colors of RGB can be emitted by installing a laser light source (LD: Laser Diode) for the respective colors of RGB.

The polarization split element 26 polarization-splits the emitted light L1 emitted from the first light source unit 24. That is, the polarization split element 26 splits the emitted light L1 into first split light L3 in the first polarization state and second split light L4 in the second polarization state.

For example, a polarizing beam splitter (PBS) is used as the polarization split element 26. Then, the emitted light L1 is split into s-polarized light and p-polarized light as the first split light L3 and the second split light L4.

In this case, the present technology is applicable with the s-polarized light as the first split light L3 and the p-polarized light as the second split light L4. The present technology is not limited thereto and is applicable with the p-polarized light as the first split light L3 and the s-polarized light as the second split light L4.

That is, the polarization split element 26 is capable of splitting the emitted light L1 emitted from the first light source unit 24 into s-polarized light that is the first split light L3 and p-polarized light that is the second split light L4. Further, the polarization split element 26 is capable of splitting the emitted light L1 emitted from the first light source unit 24 into p-polarized light that is the first split light L3 and s-polarized light that is the second split light L4.

A PBS having an arbitrary configuration such as a prism-type PBS and a wire-grid-type PBS may be used as a PBS. Note that the wire-grid-type PBS is more affected by the generation of heat than the prism-type PBS in some cases.

Therefore, the prism-type PBS is capable of sufficiently reducing the influence of heat. Further, in the case where the prism-type PBS is used, quartz (synthetic quartz) is used as a glass material. As a result, it is advantageous for maintaining the polarization state of light travelling through the PBS and it is possible to prevent leakage light from being generated due to disturbance of the polarization state. As a result, it is possible to achieve high efficiency of light.

Note that an optical element other than a PBS may be used as the polarization split element 26. Further, two light beams in a polarization state different from linearly polarized light beams (p-polarized light and s-polarized light, or the like) having polarization directions orthogonal to each other may be emitted as the first split light L3 and the second split light L4.

The light synthesis unit 27 synthesizes the first split light L3 and the one or more laser beams L2 and emits the obtained light as synthesized light L5 in the first polarization state.

For example, the light synthesis unit 27 generates the synthesized light L5 such that the polarization state of the synthesized light L5 is equal to the polarization state of the first split light L3 before the synthesis. Such synthesized light L5 is included in the synthesized light L5 in the first polarization state.

For example, assumption is made that the polarization split element 26 splits the emitted light L1 into p-polarized light and s-polarized light. That is, assumption is made that linearly polarized light having a polarization direction of a predetermined direction is emitted as the first split light L3. In this case, the light synthesis unit 27 generates the synthesized light L5 so as to be linearly polarized light having the same polarization direction as the polarization direction of the first split light L3 before the synthesis and emits the synthesized light L5. As a result, it is possible to emit the synthesized light L5 in the first polarization state.

It goes without saying that the present technology is not limited to the case where such synthesized light L5 is generated.

The polarization synthesis element 28 polarization-synthesizes the synthesized light L5 and the second split light L4. That is, the polarization synthesis element 28 synthesizes the synthesized light L5 in the first polarization state and the second split light L4 in the second polarization state. The synthesized light is emitted light L6 of the light source device 1.

For example, a PBS can be used as the polarization synthesis element 28. Specifically, two PBSs can be used as the polarization split element 26 and the polarization synthesis element 28.

In this case, the polarization synthesis element 28 is configured such that the second split light L4 and the synthesized light L5 are p-polarized and s-polarized (any combination is possible) with respect to the optical surface. As a result, it is possible to coaxially synthesize the second split light L4 and the synthesized light L5 and emit the obtained light.

For example, it is possible to prepare two same PBSs and use them as the polarization split element 26 and the polarization synthesis element 28. It goes without saying that different two PBSs may be used.

Further, the present technology is not limited to a PBS and an arbitrary optical element capable of polarization-synthesizing the synthesized light L5 and the second split light L4 may be used.

Note that in the case where the image display apparatus 100 illustrated in FIG. 1 is formed, the white light W1 is emitted as the emitted light L1.

Regarding display of an image by the image display apparatus 100, it is important to adjust the color gamut representing the range of reproducible (expressible) colors.

In this embodiment, the laser beam L2 of an appropriate color (wavelength band) for the color (wavelength band) of the emitted light L1 of the first light source unit 24 can be used as assist light. As a result, it is possible to realize the image display apparatus 100 (light source device 1) with excellent color reproducibility.

The number and wavelength band of the one or more laser beams L2 may be appropriately set, for example, so as to achieve a desired color gamut (color reproducibility).

FIG. 3 is a schematic diagram showing a specific configuration example of the light source device 1.

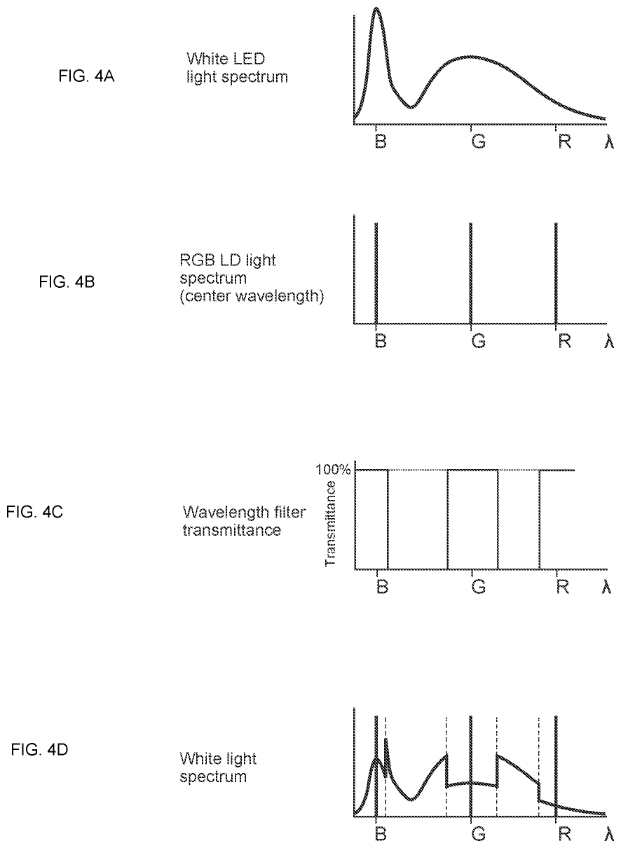

FIG. 4 is a graph for describing characteristics of an optical element and a light source included in the light source device 1.

The light source device 1 shown in FIG. 3 includes a white LED 30, a collimator lens 31, a red LD 32, a green LD 33, a blue LD 34, and a lens system 35. Further, the light source device 1 includes two PBSs 36 and 37, a mirror 38, and a wavelength filter 39.

The white LED 30 emits white light W2.

For example, the white LED 30 including a blue LED and a fluorescent material that emits yellow light is used. Then, the white light W2 having the wavelength spectrum shown in Part A of FIG. 4 is emitted. It goes without saying that regarding the application of the present technology, the configuration of the white LED 30 and the wavelength spectrum of the white light W2 are not limited.

The white light W2 is emitted from the white LED 30 with a predetermined direction as the emission direction.

The white LED 30 is an embodiment of the first light source unit 24 shown in FIG. 2. Further, the white light W2 corresponds to the light L1 having a predetermined wavelength range and in the unpolarized state, which is shown in FIG. 2.

The red LD 32, the green LD 33, and the blue LD 34 respectively emit a red laser beam R2, a green laser beam G2, and a blue laser beam B2. As shown in Part B of FIG. 4, each of the red laser beam R2, the green laser beam G2, and the blue laser beam B2 is a laser beam having the center wavelength included in the wavelength band of the white light W2.

The red LD 32, the green LD 33, and the blue LD 34 (hereinafter, referred to as the respective LDs of RGB in some cases) are disposed such that the emission directions of the red laser beam R2, the green laser beam G2, and the blue laser beam B2 (hereinafter, referred to as the respective laser beams of RGB in some cases) are equal to each other.

Further, the respective laser beams of RGB are emitted as linearly polarized light with the polarization direction that has been made uniform (i.e., in the same polarization state).

The respective LDs of RGB correspond to an embodiment of the second light source unit 25 shown in FIG. 25. The respective laser beams of RGB correspond to the one or more laser beams L2 shown in FIG. 2.

As shown in FIG. 2, in this embodiment, the emission directions of the respective laser beams of RGB are set so as to be orthogonal to the emission direction of the white light W2 from the white LED 30.

In the following description, for ease of description, assumption is made that the emission directions of the respective laser beams of RGB are the X direction and the emission direction of the white light W is the Y direction.

Further, description will be made with the X direction as the right and left direction and the Y direction as the up and down direction. The side to which the arrow of the X direction is directed is the right side, and the side opposite thereto is the left side. Further, the side to which the arrow of the Y direction is directed is the upper side, and the side opposite thereto is the lower side.

It goes without saying that regarding the application of the present technology, the orientation in which the light source device 1 is used, and the like are not limited.

In this embodiment, as shown in FIG. 2, the white LED 30 emits the white light W2 upward along the Y direction.

The respective LDs of RGB are disposed on the upper left side with respect to the white LED 30. The respective LDs of RGB emit the respective laser beams of RGB rightward along the X direction.

The collimator lens 31 is disposed on the emission side of the white LED 30 and collimates the white light W2.

The lens system 35 is disposed on the emission side of the respective LDs of RGB. The lens system 35 includes, for example, a condenser lens and a collimator lens and emits the respective laser beams of RGB along a predetermined optical path.

The PBS 36 is disposed on the optical path of the white light W2 emitted from the white LED 30.

The PBS 36 has an optical surface 36a for splitting the white light W2 into p-polarized light Lp and s-polarized light Ls. The optical surface 36a is disposed at an angle of 45 degrees with respect to the emission direction of the white light W2 (the Y direction).

Of the white light W, the p-polarized light Lp is transmitted through the optical surface 36a of the PBS 36 and travels upward along the Y direction.

Of the white light W, the s-polarized light Ls is reflected by the optical surface 36a of the PBS 36 and travels leftward along the X direction.

The PBS 36 is an embodiment of the polarization split element 26 shown in FIG. 2. Further, the s-polarized light Ls corresponds to the first split light L3 shown in FIG. 2, and the p-polarized light Lp corresponds to the second split light L4. Therefore, in this embodiment, the PBS 36 splits the white light W2 emitted from the white LED 30 into s-polarized light Ls that is the first split light L3 and p-polarized light that is the second split light L4.

Hereinafter, light in the same polarization state as the p-polarized light Lp will be referred to as the light of p-polarized light, and light in the same polarization state as the s-polarized light Ls will be referred to as the light of s-polarized light in some cases. Further, in the drawings, p-polarized light is illustrated by a broken line.

The mirror 38 is disposed on the optical path of the s-polarized light Ls reflected by the PBS 36. Therefore, the mirror 38 is disposed so as to line up on the left side along the X direction with respect to the PBS 36. Further, the mirror 38 is disposed at an angle of 45 degrees with respect to the emission direction of the s-polarized light Ls (the X direction).

The mirror 38 reflects, upward along the Y direction, the s-polarized light reflected leftward along the X direction. At this time, the polarization state of the s-polarized light Ls is maintained.

As shown in FIG. 3, the wavelength filter 39 is disposed on the optical paths of the respective laser beams of RGB emitted from the respective LDs of RGB. Further, the wavelength filter 39 is disposed on the optical path of the s-polarized light reflected by the mirror 38.

Further, the wavelength filter is disposed at an angle of 45 degrees with respect to the emission directions of the respective laser beams of RGB (the X direction) and the emission direction of the s-polarized light Ls (the Y direction).

The wavelength filter 39 has filter characteristics of causing light in a predetermined wavelength band to be transmitted therethrough and reflecting light in another wavelength band. That is, a dichroic mirror is used as the wavelength filter 39. The wavelength filter 39 can also be referred to as a wavelength split filter.

In this embodiment, as shown in Part C of FIG. 4, the wavelength filter 39 causes light beams in the wavelength bands of the respective laser beams of RGB to be transmitted therethrough and reflects light in a wavelength band different from the wavelength bands of the respective laser beams of RGB.

Therefore, the wavelength filter 39 causes the respective laser beams of RGB emitted from the respective LDs of RGB to be transmitted rightward along the X direction. Further, the wavelength filter 39 reflects, rightward along the X direction, light in a wavelength band different from the wavelength bands of the respective laser beams of RGB, of the s-polarized light Ls reflected by the mirror 38.

As a result, the wavelength filter 39 synthesizes the respective laser beams of RGB and the s-polarized light Ls and emits the obtained light as synthesized light LC rightward along the X direction.

In this embodiment, the respective laser beams of RGB are emitted from the respective LDs of RGB as light in the same polarization state as the s-polarized light Ls synthesized by the wavelength filter 39.

Therefore, the wavelength filter 39 emits the synthesized light LC as light in the same polarization state as the s-polarized light Ls, i.e., s-polarized light.

The specific configuration and the like of the wavelength filter are not limited, and an arbitrary filter element such as a notch filter may be used.

Note that since the respective laser beams of RGB are emitted as s-polarized light, it is possible to design the wavelength filter 39 in accordance with the polarization state. That is, it is possible to design the wavelength filter 39 having high filter characteristics by designing specialized for s-polarized light. As a result, it is possible to improve the light utilization efficiency.

In this embodiment, as the light synthesis unit 27 shown in FIG. 2, a configuration including a filter element disposed on the optical path of the one or more laser beams L2 and an optical element that emits the first split light L3 toward the filter is adopted.

The wavelength filter 39 shown in FIG. 3 is an embodiment of the filter element and the mirror 38 is an embodiment of the optical element.

That is, in this embodiment, the light synthesis unit 27 shown in FIG. 2 is realized by the wavelength filter 39 and the mirror 38.

It goes without saying that the present technology is not limited to such a configuration.

Further, the synthesized light LC corresponds to the synthesized light L5 in the first polarization state shown in FIG. 2.

The PBS 37 is disposed on the optical path of the p-polarized light Lp that is transmitted through the PBS 36. Further, the PBS 37 is disposed on the optical path of the synthesized light LC of the respective laser beams of RGB and the s-polarized light Ls.

Therefore, the two PBSs 36 and 37 are disposed so as to line up on the upper side along the Y direction with respect to the white LED 30. Further, the PBS 37 is disposed so as to line up on the right side along the X direction with respect to the respective LDs of RGB.

The PBS 37 coaxially synthesizes p-polarized light and s-polarized light with respect to the optical surface 37a and emits the obtained light.

In this embodiment, the optical surface 37a is designed so as to be capable of synthesizing the p-polarized light Lp that has been transmitted through the PBS 36 and the synthesized light LC of the respective laser beams of RGB and the s-polarized light Ls. Further, the optical surface 37a is disposed at an angle of 45 degrees with respect to each of the emission direction of the p-polarized light Lp (the Y direction) and the emission direction of the synthesized light LC (the X direction).

Therefore, the optical surface 37a causes the p-polarized light Lp that has been transmitted through the PBS 36 to be transmitted upward along the Y direction. Further, the optical surface 37a reflects, upward along the Y direction, the synthesized light LC entering from the left side along the X direction.

As a result, the p-polarized light Lp and the synthesized light LC are synthesized by the PBS 37, and the obtained light is emitted as the white light W1 shown in FIG. 1 upward along the Y direction.

The PBS 37 is an embodiment of the polarization synthesis element 28 shown in FIG. 2. Further, the white light W1 corresponds to the synthesized light L5 shown in FIG. 2.

Part D of FIG. 4 is a graph showing the wavelength spectrum of the white light W1.

The white light W1 is light including the p-polarized light Lp, the respective laser beams of RGB, and light in a wavelength band different from the wavelength bands of the respective laser beams of RGB, of the s-polarized light Ls.

The amount of light (light intensity) of the p-polarized light Lp and the s-polarized light Ls is half that of the entire white light W2.

In a wavelength band where the transmittance is 0% (wavelength band different from the wavelength bands of the respective laser beams of RGB), of the transmittances of the wavelength filter 39 shown in Part C of FIG. 4, the p-polarized light Lp and the s-polarized light Ls are included, so that the white light W2 is emitted as it is.

In a wavelength band where the transmittance is 100% (wavelength bands of the respective laser beams of RGB), the respective laser beams of RGB and the p-polarized light Lp are included. Therefore, in the wavelength band, the amount of light of the white light W1 is halved.

It goes without saying that some light loss can occur when the respective light beams travel through the light source device 1. However, it is possible to emit the white light W1 based on the wavelength spectrum illustrated in Part D of FIG. 4.

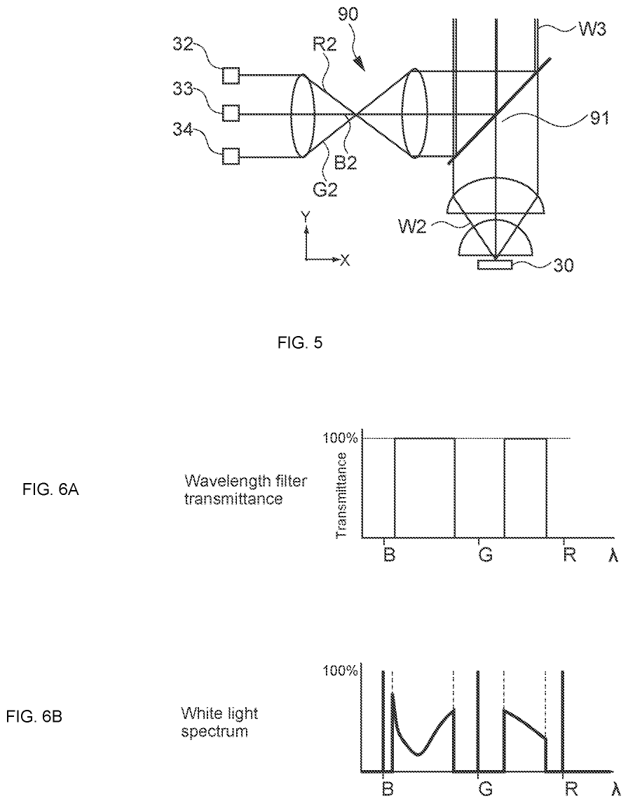

FIG. 5 is a schematic diagram showing a configuration example of a light source device 90 according to a Comparative Example.

FIG. 6 is a graph for describing characteristics of an optical element and a light source included in the light source device 90.

In the light source device 90, the two PBSs 36, and 27 are not used. That is, the light source device 90, the polarization split element 26 and the polarization synthesis element 28 shown in FIG. 2 are not used.

In the light source device 90, the white light W2 and the respective laser beams of RGB are synthesized by a wavelength filter (dichroic mirror) 91.

As shown in FIG. 5, in the light source device 90, the white light W2 is emitted from the white LED 30 upward along the Y direction. Further, the red laser beam R2, the green laser beam G2, and the blue laser beam B2 are respectively emitted from the red LD 32, the green LD 33, and the blue LD 34 rightward along the X direction.

The wavelength filter 91 is disposed on the optical path of the white light W2 from the white LED 30. Further, the wavelength filter 91 is disposed on the optical paths of the respective laser beams of RGB emitted from the respective LDs of RGB.

Further, the wavelength filter is disposed at an angle of 45 degrees with respect to each of the emission direction of the white light W2 (the Y direction) and the emission directions of the respective laser beams of RGB (the X direction).

Further, as shown in Part A of FIG. 6, the wavelength filter 91 reflects light beams in the wavelength bands of the respective laser beams of RGB and causes light in a wavelength band different from the wavelength bands of the respective laser beams of RGB to be transmitted therethrough.

Therefore, the wavelength filter 91 reflects, upward along the Y direction, the respective laser beams of RGB emitted from the respective LDs of RGB. Further, the wavelength filter 39 causes light in a wavelength band different from the wavelength bands of the respective laser beams of RGB, of the white light W2, to be transmitted upward along the Y direction.

As a result, the laser beams of the respective colors of RGB and the white light W2 are synthesized by the wavelength filter 91, and the obtained light is emitted as white light W3 upward along the Y direction.

Part B of FIG. 6 is a graph showing the wavelength spectrum of the white light W3.

The white light W3 is light including the respective laser beams of RGB, and light in a wavelength band different from the wavelength bands of the respective laser beams of RGB, of the white light W2.

In a wavelength band where the transmittance is 100% (wavelength band different from the wavelength bands of the respective laser beams of RGB), of the transmittances of the wavelength filter 91 shown in Part A of FIG. 6, the white light W2 is emitted as it is.

In a wavelength band where the transmittance is 0% (wavelength bands of the respective laser beams of RGB), the respective laser beams of RGB are emitted as they are. Meanwhile, in the wavelength band, the white light W2 is cut. Therefore, in the wavelength band, only laser beams of the respective colors are emitted.

As described above, in the light source device 90, when synthesizing the white light W2 and laser beams of the respective colors, part of the white light W2 is cut. Therefore, the light utilization efficiency is reduced.

Further, since only the respective laser beams of RGB are emitted in the wavelength bands of the respective laser beams of RGB, speckles tend to occur due to the coherence of each laser beam. When speckles occur, the image quality of an image displayed by the image display apparatus 100 is reduced.

Meanwhile, in the light source device 1 according to this embodiment, it is possible to emit the white light W2 having the wavelength spectrum shown in Part D of FIG. 4. That is, in the wavelength bands of the respective laser beams of RGB, it is possible to emit the p-polarized light Lp of the white light W2.

As a result, it is possible to improve the light utilization efficiency and achieve high luminance of the image display apparatus 100 (light source device 1). Further, it is possible to suppress the occurrence of speckles due to the coherence of each laser beam. As a result, it is possible to achieve display of a high-quality image.

Note that also in the light source device 90 shown in FIG. 5, a configuration in which the green laser beam G2 emitted from the green LD 33 is used as assist light is adopted, similarly to the light source device 1 shown in FIG. 3.

The use of the green laser beam G2 as assist light is a technology that has not existed in the past, and is a technology newly devised by the present inventors.

Also in the light source device 90, high color reproducibility is achieved by using the green laser beam G2 as assist light.

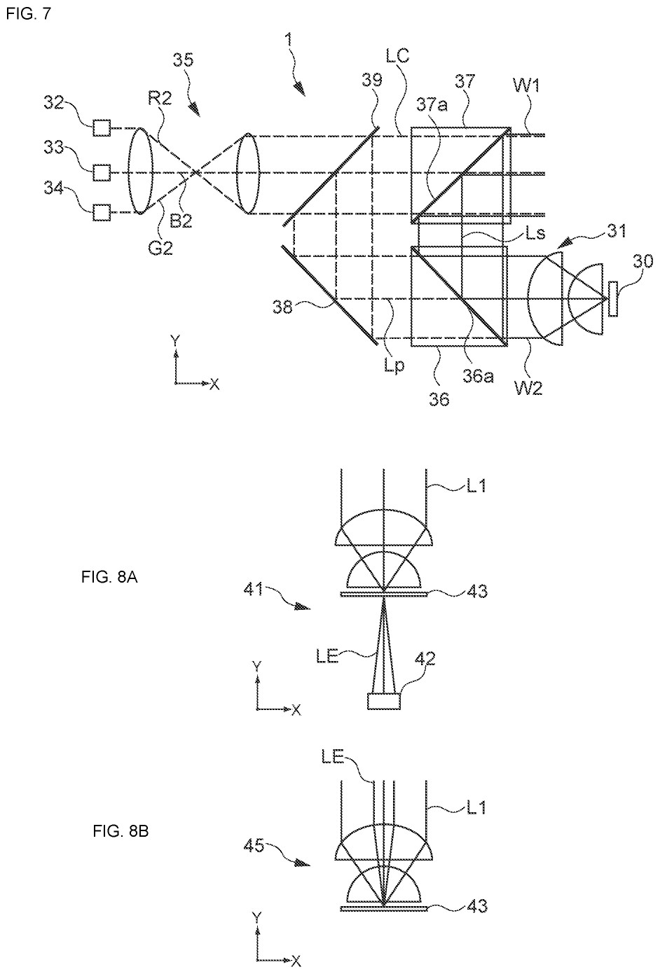

FIG. 7 is a schematic diagram showing another configuration example of the light source device 1.

In the light source device 1 shown in FIG. 7, the white LED 30 is disposed so as to line up on the right side along the X direction with respect to the PBS 36. Then, the white light W2 is emitted from the white LED 30 leftward along the X direction.

Further, as illustrated by a broken line in FIG. 7, the respective LDs of RGB emit laser beams of the respective colors as the light of p-polarized light.

The PBS 36 causes the p-polarized light Lp of the white light W2 to be transmitted leftward along the X direction. Further, the PBS 36 reflects the s-polarized light Ls of the white light W2 upward along the Y direction.

In this embodiment, the p-polarized light Lp corresponds to the first split light L3 shown in FIG. 2, and the s-polarized light Ls corresponds to the second split light L4. Therefore, in this embodiment, the PBS 36 splits the white light W2 emitted from the white LED 30 into the p-polarized light Lp that is the first split light L3 and s-polarized light that is the second split light L4.

The mirror 38 reflects, upward along the Y direction, the p-polarized light Lp that has been transmitted leftward along the X direction. At this time, the polarization state of the p-polarized light Lp is maintained.

The wavelength filter 39 causes the respective laser beams of RGB emitted from the respective LDs of RGB to be transmitted rightward along the X direction. Further, the wavelength filter 39 reflects, rightward along the X direction, light in a wavelength band different from the wavelength bands of the respective laser beams of RGB, of the p-polarized light Lp reflected by the mirror 38.

As a result, the respective laser beams of RGB and the p-polarized light Lp are synthesized by the wavelength filter 39, and the obtained light is emitted as the synthesized light LC rightward along the X direction. The synthesized light LC is emitted as light in the same polarization state as the p-polarized light Lp, i.e., the light of p-polarized light.

The PBS 37 reflects, rightward along the X direction, the s-polarized light Ls reflected by the PBS 36. Further, the PBS 37 causes the synthesized light LC entering from the left side along the X direction to be transmitted rightward along the X direction.

As a result, the s-polarized light Ls and the synthesized light LC are synthesized by the PBS 37 and the obtained light is emitted as the white light W1 shown in FIG. 1 rightward along the X direction. The white light W1 has the wavelength spectrum shown in Part D of FIG. 4.

As a result, similarly to the light source device 1 shown in FIG. 3, it is possible to realize the light source device 1 with high efficiency and excellent color reproducibility (the image display apparatus 100). Further, it is possible to suppress the occurrence of speckles and achieve display of a high-quality image.

FIG. 8 is a schematic diagram showing another example of the first light source unit 24.

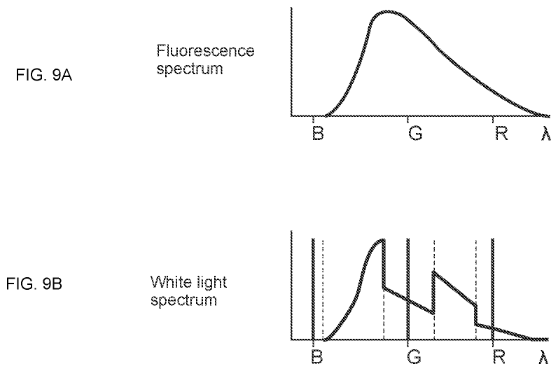

FIG. 9 is a schematic diagram for describing each device and characteristics of light in the case where the configuration shown in FIG. 8 is adopted.

As shown in Part A of FIG. 8, a transmissive phosphor light source 41 may be used as the first light source unit 24.

The transmissive phosphor light source 41 includes an excitation light source 42 that emits excitation light LE and a fluorescent material 43. The fluorescent material 43 is applied to a transparent substrate (not shown) that causes light to be transmitted therethrough.

As shown in Part A of FIG. 8, the excitation light LE of the excitation light source 42 is applied from the lower side in the Y direction to the fluorescent material 43. The fluorescent material 43 is excited by the excitation light to emit fluorescence. The fluorescence becomes the emitted light L1 of the first light source unit 24 and is emitted upward along the Y direction.

For example, a blue laser beam is used as the excitation light LE. Then, as shown in Part A of FIG. 9, fluorescence in a yellow wavelength band is emitted from the fluorescent material 43.

As shown in Part B of FIG. 9, by applying the present technology, in the wavelength bands of the red laser beam R2 and the green laser beam G2, it is possible to emit the white light W1 including half the light (p-polarized light or s-polarized light) of the emitted light L1 in a yellow wavelength band.

As a result, it is possible to realize the light source device 1 with high efficiency and excellent color reproducibility. Further, it is possible to suppress the occurrence of speckles.

In the example shown in Part A of FIG. 9, light in a yellow wavelength band is emitted. Therefore, the present technology is applied with the red laser beam R2 and the green laser beam G2 as the one or more laser beams L2 shown in FIG. 2

Note that the transmissive phosphor light source 41 can be used for both the configuration shown in FIG. 3 and the configuration shown in FIG. 5.

As shown in Part B of FIG. 8, a reflective phosphor light source 45 may be used as the first light source unit 24.

The reflective phosphor light source 41 includes an excitation light source (not shown) that emits the excitation light LE and the fluorescent material 43. The fluorescent material 43 is applied to a reflective substrate (not shown) that reflects light.

As shown in Part B of FIG. 8, the excitation light LE is applied from the upper side in the Y direction to the fluorescent material 43. The fluorescent material 43 is excited by the excitation light to emit fluorescence upward along the Y direction. The fluorescence becomes the emitted light L1.

Also in the configuration shown in Part B of FIG. 8, it is possible to emit the fluorescence (emitted light L1) and the white light W1, which have the wavelength spectra shown in Parts A and B of FIG. 9, for example. Therefore, it is possible to realize the light source device 1 with high efficiency and excellent color reproducibility. Further, it is possible to suppress the occurrence of speckles.

It goes without saying that the reflective phosphor light source 45 can be used for both the configuration shown in FIG. 3 and the configuration shown in FIG. 5.

Each of the transmissive phosphor light source 41 and the reflective phosphor light source 45 respectively shown in Parts A and B of FIG. 8 can be used as a white light source.

For example, it is also possible to emit white light including a blue laser beam LE that is excitation light and fluorescence that is yellow light as the emitted light L1 of the first light source unit 24. Note that the blue laser beam LE that enters the fluorescent material 43 and is emitted as it is as the emitted light L1 is the light in the unpolarized state.

Therefore, the emitted light L1 emitted from the phosphor light sources 41 and 45 is light having a predetermined wavelength band and in the unpolarized state.

A phosphor wheel configured to be rotatable may be used in each of the transmissive phosphor light source 41 and the reflective phosphor light source 45 respectively shown in Parts A and B of FIG. 8. For example, a transparent substrate or a reflective substrate to which the fluorescent material 43 is applied is caused to rotate by a motor or the like. As a result, it is possible to suppress the influence of heat generated by the application of the excitation light LE to the fluorescent material 43.

In addition, as the specific configuration of the transmissive phosphor light source 41 and the reflective phosphor light source 45, an arbitrary configuration may be adopted.

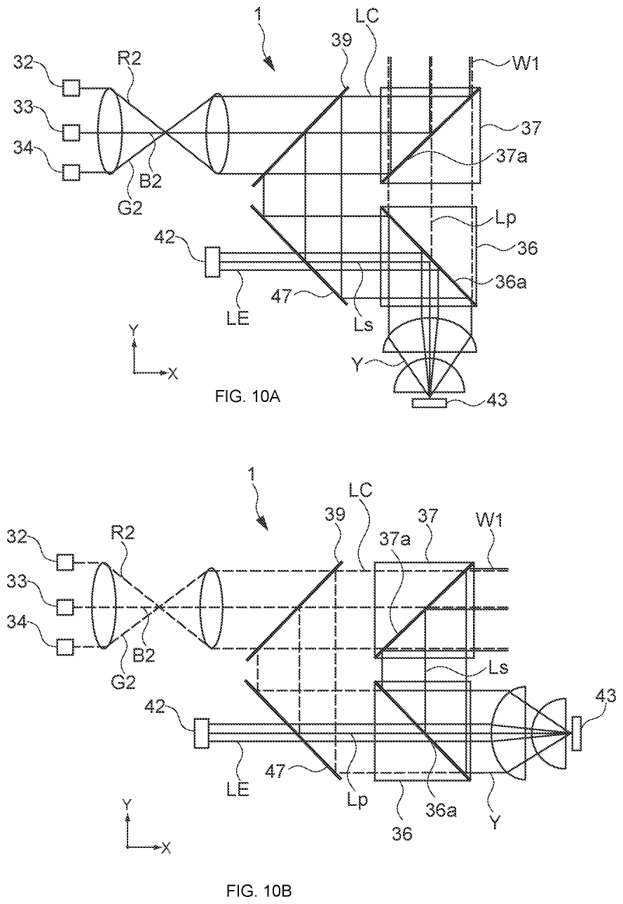

FIG. 10 is a schematic diagram showing a configuration example of the light source device 1 in the case where the reflective phosphor light source 45 is used.

First, a case where the reflective phosphor light source 45 is used instead of the white LED 30 of the light source device 1 shown in FIG. 3 will be described as an example with reference to Part A of FIG. 10.

As shown in Part A of FIG. 10, a reflective substrate (not shown) to which the fluorescent material 43 is applied is disposed at the position of the white LED 30.

Further, a wavelength filter 47 is disposed instead of the mirror 38. Similarly to the mirror 38, the wavelength filter 47 is disposed at an angle of 45 degrees with respect to the Y direction.

Further, the excitation light source 42 is disposed so as to line up on the left side of the wavelength filter 47 along the X direction. Therefore, the excitation light source 42, the wavelength filter 47, and the PBS 36 line up along the X direction.

The excitation light source 42 emits the excitation light LE rightward along the X direction. Further, the excitation light source 42 emits, as light in the first polarization state, the excitation light LE that becomes s-polarized light.

The wavelength filter 47 causes light in the wavelength band of the excitation light LE to be transmitted therethrough and reflects light in a wavelength band different from the wavelength band of the excitation light LE. That is, a dichroic mirror is used as the wavelength filter 47.

Therefore, the excitation light LE emitted from the excitation light source 42 is transmitted through the wavelength filter 47 to enter the PBS 36. The excitation light LE is reflected by the PBS 36 downward along the Y direction to enter the fluorescent material 43. That is, the excitation light LE is transmitted through the wavelength filter 47 and then applied to the fluorescent material 43 via the PBS 36.

The p-polarized light Lp of yellow light Y emitted from the fluorescent material 43 is transmitted through the PBS 36 to enter the PBS 37.

The s-polarized light Ls of the yellow light Y emitted from the fluorescent material 43 is reflected by the wavelength filter 47 and synthesized with laser beams of the respective colors by the wavelength filter 39. The synthesized light LC of the laser beams of the respective colors and the s-polarized light Ls enters the PBS 37.

The PBS 37 synthesizes the p-polarized light Lp and the synthesized light LC and emits the obtained light as the white light W1.

A case where the reflective phosphor light source 45 is used instead of the white LED 30 of the light source device 1 shown in FIG. 5 will be described with reference to Part B of FIG. 10.

As shown in Part B of FIG. 10, a reflective substrate (not shown) to which the fluorescent material 43 is applied is disposed at a position of the white LED 30.

The wavelength filter 47 is disposed instead of the mirror 38.

The excitation light source 42 is disposed so as to line up on the left side of the wavelength filter 47 along the X direction.

In the example shown in Part B of FIG. 10, the excitation light source 42 emits the excitation light LE that becomes p-polarized light as light in the first polarization state.

The wavelength filter 47 causes light in the wavelength band of the excitation light LE to be transmitted therethrough and reflects light in a wavelength band different from the wavelength band of the excitation light LE.

Therefore, the excitation light LE is transmitted through the wavelength filter 47 and then applied to the fluorescent material 43 via the PBS 36.

The s-polarized light Ls of the yellow light Y emitted from the fluorescent material 43 is reflected by the PBS 36 to enter the PBS 37.

The p-polarized light Lp of the yellow light Y emitted from the fluorescent material 43 is reflected by the wavelength filter 47 and synthesized with laser beams of the respective colors by the wavelength filter 39. The synthesized light LC of the laser beams of the respective colors and the p-polarized light Lp enters the PBS 37.

The PBS 37 synthesizes the s-polarized light Lp and the synthesized light LC and emits the obtained light as the white light W1.

The PBS 36 shown in Parts A and B of FIG. 10 functions as the polarization split element 24 shown in FIG. 2. Further, the wavelength filter 47 functions as an optical element constituting the light synthesis unit 27 shown in FIG. 2.

Meanwhile, the PBS 36 and the wavelength filter 47 function also as an optical system that applies the excitation light LE to the fluorescent material 43.

In this way, the optical system for forming the light source device 1 shown in FIG. 2 can be partially shared and used as the optical system that applies the excitation light LE to the fluorescent material 43. As a result, it is possible to achieve miniaturization of the light source device 1 and achieve miniaturization of the image display apparatus 100.

As described above, in this light source device, the light L1 having a predetermined wavelength band and in the unpolarized state is split into the first split light L3 and the second split light L4. The first split light L3 is synthesized with one or more laser beams, and the obtained synthesized light LC is synthesized with the second split light L4. As a result, it is possible to realize a light source device with high efficiency and excellent color reproducibility. Further, it is possible to suppress the occurrence of speckles due to the coherence of each laser beam. As a result, it is possible to achieve display of a high-quality image.

In the case where a phosphor light source is used as a light source, the brightness is limited due to luminance saturation and temperature quenching of a fluorescent material. For example, in the case where a blue laser beam is used as excitation light, the amount of light emitted from a fluorescent material does not increase linearly even if the intensity of the blue laser beam is increased, making it difficult to increase the luminance.

In the light source device 1 according to this embodiment, one or more laser beams can be used as assist light, which is advantageous for increasing the luminance. Further, broad light in the unpolarized state is polarization-split once, and one of the split light beams is synthesized with one or more laser beams. Then, the obtained synthesized light is synthesized with the other of the split light beams.

As a result, it is possible to suppress loss when synthesizing broad light in the unpolarized state and a laser beam and emit bright light with high utilization efficiency. Further, by appropriately adjusting the wavelength band, amount of light, and the like of one or more laser beams, it is possible to improve color reproducibility. Further, it is also possible to suppress the occurrence of speckles.

Further, appropriately designing the first light source unit 24 and the second light source unit 25, it is possible to flexibly control the luminance, color gamut, color rendering properties (what color an object irradiated with light looks like), and the like of the emitted light L6.

### OTHER EMBODIMENTS

The present technology is not limited to the embodiment described above, and various other embodiments can be implemented.

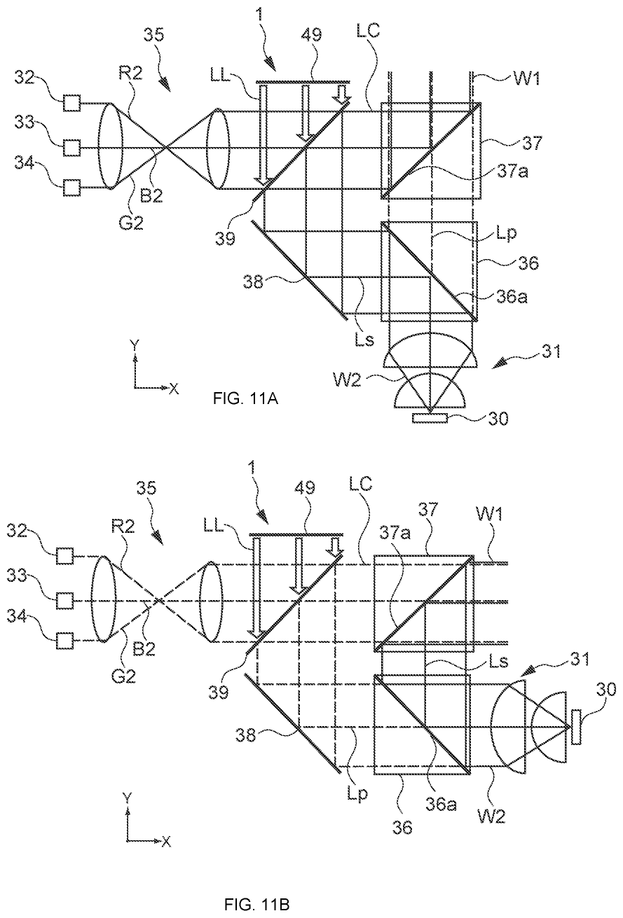

FIG. 11 is a schematic diagram showing another configuration example of the light source device 1.

In the light source device 1 shown in Part A of FIG. 11, a mirror 49 is disposed on the upper side of the wavelength filter 39 along the Y direction. Further, the mirror 49 is disposed so as to be orthogonal to the Y direction.

The mirror 49 reflects leakage light LL that has not been emitted as the synthesized light LC by the wavelength filter 39, of the s-polarized light Ls emitted as the first split light L3, so as to travel in the opposite direction of the optical path of the s-polarized light Ls from the mirror 38 to the wavelength filter 39. As a result, it is possible to return the leakage light LL to the light-emitting point.

The leakage light LL returned to the light-emitting point is emitted again as the light in the unpolarized state. Therefore, it is split into the p-polarized light Lp and the s-polarized light Ls, passes through the optical path described above, and is emitted again as the white light W1.

By disposing the mirror 49, it is possible to realize an optical system including polarization recycling and improve the light utilization efficiency.

Also in the light source device 1 shown in Part B of FIG. 11, the leakage light LL that has not been emitted as the synthesized light LC by the wavelength filter 39, of the p-polarized light Lp emitted as the first split light L3, is reflected by the mirror 49 so as to travel in the opposite direction of the optical path of the p-polarized light Lp from the mirror 38 to the wavelength filter 39. As a result, it is possible to improve the light utilization efficiency.

Note that the optical system including polarization recycling shown in FIG. 11 can be realized regardless of the specific configuration of the first light source unit 24.

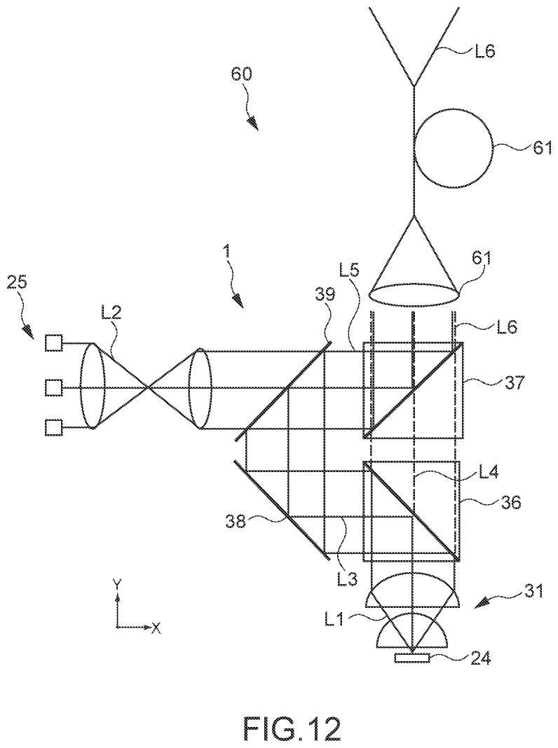

FIG. 12 is a schematic diagram showing an application example of the light source device 1.

A case where the light source device 1 is applied to the image display apparatus 100 such as a projector has been described above as an example.

The present technology is not limited thereto, and the light source device 1 according to the present technology can be applied to various apparatuses in various fields.

For example, FIG. 12 is a schematic diagram showing a configuration example of a medical device 60 to which the light source device 1 is applied. The medical device 60 includes the light source device 1, a condenser lens 61, and an optical fiber 62.

The condenser lens 61 collects the emitted light L6 emitted from the light source device 1 and causes the collected light to enter the optical fiber 62. The emitted light L6 is emitted from the optical fiber 62.

Examples of the medical device 60 include an arbitrary device such as an endoscope and a surgical microscope.

In the light source device 1 according to the present technology, it is possible to flexibly control the luminance, color gamut, and color rendering properties of the emitted light L6. Therefore, it is possible to easily make the light to be applied to an affected area light closer to natural light or light including a lot of light of a specific wavelength band.

It goes without saying that the present technology can be applied to not only medical and biological fields but also an observation device, an observation system, and the like in various other fields. The present technology is applicable to an arbitrary light source that requires the brightness, color gamut, color rendering properties, and the like.

The wavelength filter 39 has been described above as an example of a filter element constituting the light synthesis unit 27 shown in FIG. 2. The present technology is not limited thereto, and a spatial filter may be used as a filter element.

For example, in the configuration shown in FIG. 3 or FIG. 5, a spatial filter that includes an opening at a position corresponding to the optical paths of laser beams of the respective colors and a mirror at a position different from those of the optical paths of laser beams of the respective colors is used.

The spatial filter is capable of emitting the synthesized light LC by causing laser beams of the respective colors to be transmitted from the opening and reflecting, by the mirror, the s-polarized light Ls (p-polarized light Lp in FIG. 5) emitted as the first split light L3.

In this case, the s-polarized light Ls (p-polarized light Lp in FIG. 5) emitted as the first split light L3 can leak from the opening of the spatial filter. However, since the amount of the leakage light is half the amount of the original emitted light L1, it is possible to achieve high light utilization efficiency.

In a three-panel projector as illustrated in FIG. 1, or the like, a bloc for generating a blue image may be formed independently of blocks for generating a red image and a green image. In this case, the present technology can be applied to a light source device that emits yellow light for generating a red image and a green image.

In this case, a red laser beam and a green laser beam are emitted as one or more laser beams and a blue laser beam is unnecessary. Therefore, it is easy to design a filter element for synthesizing one or more laser beams and first split light.

Assumption is made that a wavelength filter is used to synthesize one or more laser beams and first split light. In this case, a wavelength filter that reflects light in a wavelength band of each of the one or more laser beams and causes light in a wavelength band different from the wavelength band of each of the one or more laser beams to be transmitted therethrough may be used. The wavelength filter emits synthesized light by reflecting the one or more laser beams and causing the first split light to be transmitted therethrough.

Assumption is made that a spatial filter is used to synthesize one or more laser beams and first split light. In this case, a spatial filter that includes a mirror at a position corresponding to the optical paths of the one or more laser beams and an opening at a position different from those of the optical paths of the one or more laser beams may be used. The spatial filter emits synthesized light by reflecting the one or more laser beams by the mirror and causing the first split light to be transmitted from the opening.

An optical element constituting a light synthesis unit may reflect light in a wavelength band of excitation light and cause light in a wavelength band different from the wavelength band of the excitation light to be transmitted therethrough. In this case, the excitation light is reflected by the optical element and then applied to a light-emitting body via a polarization split element.

The configurations of the image display apparatus, the light source device, the medical device, and the like described with reference to the drawings, the filter characteristics, the wavelength spectrum, the optical path, and the like are merely an embodiment, and can be arbitrarily modified without departing from the essence of the present technology. That is, other arbitrary configurations and other arbitrary algorithms for implementing the present technology may be adopted.

In the present disclosure, in the case where the word “substantially” is used, it is used only to facilitate the understanding of description, and the use/non-use of the word “substantially” has no special meaning.

That is, in the present disclosure, concepts defining a shape, a size, a positional relationship, a state, and the like, such as “central”, “middle”, “uniform”, “equal”, “the same”, “orthogonal”, “parallel”, “symmetrical”, “extended”, “axial direction”, “columnar shape”, “cylindrical shape”, “ring shape”, and “annular shape”, are concepts including “substantially central”, “substantially middle”, “substantially uniform”, “substantially equal”, “substantially the same”, “substantially orthogonal”, “substantially parallel”, “substantially symmetrical”, “substantially extended”, “substantially axial direction”, “substantially columnar shape”, “substantially cylindrical shape”, “substantially ring shape”, “substantially annular shape”, and the like.

For example, a state included in a predetermined range (e.g., a range of ±10%) based on “completely central”, “completely middle”, “completely uniform”, “completely equal”, “completely the same”, “completely orthogonal”, “completely parallel”, “completely symmetrical”, “completely extended”, “completely axial direction”, “completely columnar shape”, “completely cylindrical shape”, “completely ring shape”, “completely annular shape”, and the like is also included.

Therefore, even in the case where the word “substantially” is not added, a concept expressed by adding a so-called “substantially” can be included. On the contrary, the complete state is not excluded from the state expressed by adding “substantially”.

In the present disclosure, expressions using “than” such as “larger than A” and “smaller than A” comprehensively include both the concept including the case where it is equivalent to A and the concept not including the case where it is equivalent to A. For example, the phrase “larger than A” is not limited to the case not including being equivalent to A and includes “A or more”. Further, the phrase “smaller than A” is not limited to “less than A” and includes “A or less”.

When implementing the present technology, specific settings and the like only need to be appropriately adopted from the concepts included in “larger than A” and “smaller than A” such that the effects described above are exhibited.

Of the feature portions according to the present technology described above, at least two feature portions can be combined. That is, the various feature portions described in the respective embodiments may be arbitrarily combined with each other without distinguishing the respective embodiments from each other. Further, the various effects described above are merely illustrative and are not limitative, and other effects may be exhibited.

It should be noted that the present technology may also take the following configurations.
(1) A light source device, including:
   a first light source unit that emits light having a predetermined wavelength band and in an unpolarized state;
   a polarization split element that splits emitted light emitted from the first light source unit into first split light in a first polarization state and second split light in a second polarization state;
   a second light source unit that emits one or more laser beams each having a wavelength band included in the predetermined wavelength band;
   a light synthesis unit that synthesizes the first split light and the one or more laser beams and emits the obtained light as synthesized light in the first polarization state; and
   a polarization synthesis element that synthesizes the synthesized light and the second split light.
(2) The light source device according to (1), in which
   the first light source unit emits lamp light, LED (Light Emitting Diode) light, or emitted light emitted from a light-emitting material.
(3) The light source device according to (1) or (2), in which
   the first light source unit emits light having at least a yellow wavelength band, and
   the second light source unit emits at least one of a red laser beam or a green laser beam.
(4) The light source device according to any one of (1) to (3), in which
   the light synthesis unit includes a filter element disposed in an optical path of the one or more laser beams and an optical element that emits the first split light toward the filter element.
(5) The light source device according to (4), in which
   the filter element includes a wavelength filter that causes light in a wavelength band of each of the one or more laser beams to be transmitted therethrough and reflects light in a wavelength band different from the wavelength band of each of the one or more laser beams, and emits the synthesized light by causing the one or more laser beams to be transmitted therethrough and reflecting the first split light.
(6) The light source device according to (4), in which
   the filter element includes a wavelength filter that reflects light in a wavelength band of each of the one or more laser beams and causes light in a wavelength band different from the wavelength band of each of the one or more laser beams to be transmitted therethrough, and emits the synthesized light by reflecting the one or more laser beams and causing the first split light to be transmitted therethrough.
(7) The light source device according to (4), in which
   the filter element includes a spatial filter that includes an opening at a position of the optical path of the one or more laser beams and a mirror at a position different from that of the optical path of the one or more laser beams, and emits the synthesized light by causing the one or more laser beams to be transmitted through the opening and reflecting the first split light by the mirror.
(8) The light source device according to (4), in which
   the filter element includes a spatial filter that includes a mirror at a position of the optical path of the one or more laser beams and an opening at a position different from that of the optical path of the one or more laser beams, and emits the synthesized light by reflecting the one or more laser beams by the mirror and causing the first split light to be transmitted through the opening.
(9) The light source device according to any one of (1) to (8), in which
   the polarization split element splits the emitted light emitted from the first light source unit into s-polarized light that is the first split light and p-polarized light that is the second split light,
   the second light source unit emits the one or more laser beams as light in the same polarization state as the s-polarized light,
   the light synthesis unit emits the synthesized light as light in the same polarization state as the s-polarized light, and
   the polarization synthesis element synthesizes the synthesized light and the p-polarized light.
(10) The light source device according to any one of (1) to (8), in which
   the polarization split element splits the emitted light emitted from the first light source unit into p-polarized light that is the first split light and s-polarized light that is the second split light,
   the second light source unit emits the one or more laser beams as light in the same polarization state as the p-polarized light,
   the light synthesis unit emits the synthesized light as light in the same polarization state as the p-polarized light, and
   the polarization synthesis element synthesizes the synthesized light and the s-polarized light.
(11) The light source device according to any one of (1) to (10), in which
   each of the polarization split element and the polarization synthesis element includes a polarizing beam splitter.
(12) The light source device according to (4), in which
   the first light source unit includes an excitation light source and a light-emitting material that is excited by excitation light emitted from the excitation light source to emit light,
   the excitation light source emits the excitation light as light in the first polarization state,
   the optical element causes light in a wavelength band of the excitation light to be transmitted therethrough and reflects light in a wavelength band different from the wavelength band of the excitation light, and
   the excitation light is transmitted through the optical element and then applied to the light-emitting body via the polarization split element.
(13) The light source device according to (4), in which
   the first light source unit includes an excitation light source and a light-emitting material that is excited by excitation light emitted from the excitation light source to emit light,
   the excitation light source emits the excitation light as light in the first polarization state,
   the optical element reflects light in a wavelength band of the excitation light and causes light in a wavelength band different from the wavelength band of the excitation light to be transmitted therethrough, and
   the excitation light is reflected by the optical element and then applied to the light-emitting body via the polarization split element.
(14) The light source device according to (4), further including
   a mirror that reflects leakage light that has not been emitted as the synthesized light by the filter element, of the first split light, so as to travel in an opposite direction of an optical path of the first split light from the optical element to the filter element.
(15) An image display apparatus, including:
   a light source device that includes
      a first light source unit that emits light having a predetermined wavelength band and in an unpolarized state,
      a polarization split element that splits emitted light emitted from the first light source unit into first split light in a first polarization state and second split light in a second polarization state,
      a second light source unit that emits one or more laser beams each having a wavelength band included in the predetermined wavelength band,
      a light synthesis unit that synthesizes the first split light and the one or more laser beams and emits the obtained light as synthesized light in the first polarization state, and
      a polarization synthesis element that synthesizes the synthesized light and the second split light;
   an image generation system that generates an image on the basis of light from the light source device; and
   a projection system that projects the image generated by the image generation system.

### REFERENCE SIGNS LIST

1 light source device
2 image generation system
3 projection system
7R to 7G liquid crystal light valve
30 white LED
32 red LD
33 green LD
34 blue LD
36, 37 PBS
38 mirror
39 wavelength filter
41 transmissive phosphor light source
42 excitation light source
43 fluorescent material
45 reflective phosphor light source
47 wavelength filter
49 mirror
60 medical device
100 image display apparatus

1. A light source device, comprising:
a first light source unit that emits light having a predetermined wavelength band and in an unpolarized state;
a polarization split element that splits emitted light emitted from the first light source unit into first split light in a first polarization state and second split light in a second polarization state;
a second light source unit that emits one or more laser beams each having a wavelength band included in the predetermined wavelength band;
a light synthesis unit that synthesizes the first split light and the one or more laser beams and emits the obtained light as synthesized light in the first polarization state; and
a polarization synthesis element that synthesizes the synthesized light and the second split light.

2. The light source device according to claim 1, wherein
the first light source unit emits lamp light, LED (Light Emitting Diode) light, or emitted light emitted from a light-emitting material.

3. The light source device according to claim 1, wherein
the first light source unit emits light having at least a yellow wavelength band, and
the second light source unit emits at least one of a red laser beam or a green laser beam.

4. The light source device according to claim 1, wherein
the light synthesis unit includes a filter element disposed in an optical path of the one or more laser beams and an optical element that emits the first split light toward the filter element.

5. The light source device according to claim 4, wherein
the filter element includes a wavelength filter that causes light in a wavelength band of each of the one or more laser beams to be transmitted therethrough and reflects light in a wavelength band different from the wavelength band of each of the one or more laser beams, and emits the synthesized light by causing the one or more laser beams to be transmitted therethrough and reflecting the first split light.

6. The light source device according to claim 4, wherein
the filter element includes a wavelength filter that reflects light in a wavelength band of each of the one or more laser beams and causes light in a wavelength band different from the wavelength band of each of the one or more laser beams to be transmitted therethrough, and emits the synthesized light by reflecting the one or more laser beams and causing the first split light to be transmitted therethrough.

7. The light source device according to claim 4, wherein
the filter element includes a spatial filter that includes an opening at a position of the optical path of the one or more laser beams and a mirror at a position different from that of the optical path of the one or more laser beams, and emits the synthesized light by causing the one or more laser beams to be transmitted through the opening and reflecting the first split light by the mirror.

8. The light source device according to claim 4, wherein
the filter element includes a spatial filter that includes a mirror at a position of the optical path of the one or more laser beams and an opening at a position different from that of the optical path of the one or more laser beams, and emits the synthesized light by reflecting the one or more laser beams by the mirror and causing the first split light to be transmitted through the opening.

9. The light source device according to claim 1, wherein
the polarization split element splits the emitted light emitted from the first light source unit into s-polarized light that is the first split light and p-polarized light that is the second split light,
the second light source unit emits the one or more laser beams as light in the same polarization state as the s-polarized light,
the light synthesis unit emits the synthesized light as light in the same polarization state as the s-polarized light, and
the polarization synthesis element synthesizes the synthesized light and the p-polarized light.

10. The light source device according to claim 1, wherein
the polarization split element splits the emitted light emitted from the first light source unit into p-polarized light that is the first split light and s-polarized light that is the second split light,
the second light source unit emits the one or more laser beams as light in the same polarization state as the p-polarized light,
the light synthesis unit emits the synthesized light as light in the same polarization state as the p-polarized light, and
the polarization synthesis element synthesizes the synthesized light and the s-polarized light.

11. The light source device according to claim 1, wherein
each of the polarization split element and the polarization synthesis element includes a polarizing beam splitter.

12. The light source device according to claim 4, wherein
the first light source unit includes an excitation light source and a light-emitting material that is excited by excitation light emitted from the excitation light source to emit light,
the excitation light source emits the excitation light as light in the first polarization state,
the optical element causes light in a wavelength band of the excitation light to be transmitted therethrough and reflects light in a wavelength band different from the wavelength band of the excitation light, and
the excitation light is transmitted through the optical element and then applied to the light-emitting body via the polarization split element.

13. The light source device according to claim 4, wherein
the first light source unit includes an excitation light source and a light-emitting material that is excited by excitation light emitted from the excitation light source to emit light,
the excitation light source emits the excitation light as light in the first polarization state,
the optical element reflects light in a wavelength band of the excitation light and causes light in a wavelength band different from the wavelength band of the excitation light to be transmitted therethrough, and
the excitation light is reflected by the optical element and then applied to the light-emitting body via the polarization split element.

14. The light source device according to claim 4, further comprising
a mirror that reflects leakage light that has not been emitted as the synthesized light by the filter element, of the first split light, so as to travel in an opposite direction of an optical path of the first split light from the optical element to the filter element.

15. An image display apparatus, comprising:
a light source device that includes
a first light source unit that emits light having a predetermined wavelength band and in an unpolarized state,
a polarization split element that splits emitted light emitted from the first light source unit into first split light in a first polarization state and second split light in a second polarization state,
a second light source unit that emits one or more laser beams each having a wavelength band included in the predetermined wavelength band,
a light synthesis unit that synthesizes the first split light and the one or more laser beams and emits the obtained light as synthesized light in the first polarization state, and
a polarization synthesis element that synthesizes the synthesized light and the second split light;
an image generation system that generates an image on a basis of light from the light source device; and
a projection system that projects the image generated by the image generation system.
